(19) United States
(12) Patent Application Publication
(10) Pub. No.: US 2002/0152018 A1
(43) Pub. Date: Oct. 17, 2002

(54) Navigation method and device

(76) Inventor: Ralf Duckeck, Hildesheim (DE)

Correspondence Address: KENYON & KENYON, ONE BROADWAY, NEW YORK, NY, 10004, US

(21) Appl. No.: 10/019,894

(22) PCT Filed: Apr. 27, 2001
(86) PCT No.: PCT/DE01/01587

(30) Foreign Application Priority Data
Apr. 29, 2000 (DE) 100 21 171.2

(51) Int. Cl. G01C 21/32

(52) U.S. Cl. 701/201; 701/209

(57) ABSTRACT

Navigation methods and devices are described, in particular for use in vehicle navigation systems. If alternative recommendation is needed, essentially only the information (40) necessary for driving an alternative section of the original route is transmitted from a traffic control center to the vehicle navigation system. This information represents essentially only deviations from the route calculated in the vehicle navigation system.

### FIELD OF THE INVENTION

The present invention relates to a navigation method and a navigation device, in particular for use in vehicular navigation systems.

### BACKGROUND INFORMATION

On-board navigation systems may include the following subsystems: digital road map, computer module for calculating the trip route, position determining device, system administration, vehicle sensors for detecting vehicle movements, input and output units for operation and navigation.

Such on-board navigation systems may be capable of performing route planning according to various criteria autonomously and independently of a traffic control center after input of the starting point and destination. Some systems may also be capable of processing digital traffic information such as that received over RDS-TMC or GSM and calculating detour routes. It is believed, however, that one disadvantage of such a highly developed on-board system may be that the detour route for a traffic problem may not be determined by taking into account the traffic situation on this detour route or on other alternative routes. Furthermore, such systems may be incapable of responding in advance to an altered traffic situation in particular, which is being affected precisely by such rerouted traffic flows.

In addition, in some off-board navigation systems, the intelligence may be located in a control center where the route is calculated and transmitted to the vehicle with the help of beacons or wireless telephones (GSM). European Patent No. 0 814 448 refers to a combined off-board/on-board navigation system, which may be capable of calculating a start-destination route itself like an on-board navigation system. However, to be able to recommend the best possible detour to the driver, taking into account current traffic problems, it indicates that the start-destination route be calculated in the terminal while requesting a route from the control center at the same time. The control center then calculates the route, taking into account the current traffic situation and the changed traffic conditions such as those which may occur due to special traffic guidance because of construction sites, etc. After the route is calculated in the control center, a “prediction” is made about how far the user has traveled in the meantime, and then the complete remaining route to his/her destination is transmitted to the terminal.

This method may be referred to as a hybrid method because it combines the procedures of on-board systems with those of off-board systems. It is believed, however, that it may have the disadvantage that under some circumstances, very large volumes of data must be transmitted, which could result in a heavy load on the wireless network (GSM) when there are multiple users of the system and could also cause high transmission costs in the form of mobile wireless fees. The reason for this may be that the complete remaining route beginning with the current location of the vehicle and ending with the programmed destination is transmitted over the mobile wireless network. In the worst case, such a heavy burden on the wireless network might result in a considerable delay in transmission of data and in an overload of the transmission channel.

### SUMMARY OF THE INVENTION

In an exemplary embodiment and/or exemplary method of the present invention, the data required for optimized route planning, which must be transmitted from a traffic control center to a motor vehicle navigation system, is reduced to a lesser amount. Essentially, only the information needed for driving on an alternative section of the route is transmitted. This information represents deviations from the route calculated in the motor vehicle navigation system, and is therefore referred to below as delta information. It is believed that because of this measure, the entire volume of data to be transmitted remains relatively small even with a large number of users, and thus the cost for each individual remains low.

The exemplary embodiment and/or exemplary method of the present invention involves transmitting only the information actually needed over the mobile wireless network and also to efficiently utilize the on-board computer resources available in the vehicle for calculation of routes.

In contrast with strictly off-board methods, according to one aspect of the exemplary embodiment and/or exemplary method of the present invention, when the traffic situation is calm and running smoothly without problems, no data transmission at all is needed between the traffic control center and the vehicle navigation system, whereas strictly off-board systems must transmit all route information from the starting point to the destination.

According to an exemplary embodiment, the vehicle navigation system delivers the current vehicle position, the route destination and certain database version information to the traffic control center for initiating an optimized route planning. From this information, the control center is able to determine which current traffic problems and possibly even which future traffic problems are to be expected for an individual user of the system. The database version information provides the traffic control center with information regarding which database information is locally retrievable in the vehicle with regard to the various sections of the route and which is processable autonomously there. It is believed that this minimum of information is sufficient to be able to effectively and rapidly transmit the required information to the vehicle navigation system.

According to another aspect, however, the exemplary method according to the present invention may also be used for specific management of motor vehicle traffic flow. In this case, information is transmitted from a traffic control center to on-board vehicle navigation systems in the respective vehicles for the purpose of preventing traffic problems, in which case if there is a traffic problem and a plurality of feasible detour routes, the traffic flow may be distributed in an intelligent manner not only to one detour but to this plurality of detours.

According to another exemplary embodiment and/or exemplary method of the present invention, the traffic control center is able to intervene in traffic control to some extent, because not all vehicles need to be guided over the same detour route, and instead all possible reasonable detour routes may be utilized almost uniformly. This may be implemented, e.g., by selecting any feature of the user identification as a selection criterion. If a user identification is composed of digits, for example, its end digit could be used to differentiate users and for controlled rerouting into one of the plurality of route sections. In the case of end digits between 0 and 3, a detour route A could be proposed to this group of users or, if the digits are between 4 and 6, a different detour route B could be proposed accordingly. Otherwise, a route C would be proposed. Other options for dividing the group of users may also be used.

### BRIEF DESCRIPTION OF THE DRAWINGS

FIG. 1 shows a schematic block diagram of the steps of the exemplary method during a trip.

FIG. 2 shows a schematic diagram of the functional elements of the exemplary method.

FIG. 3 shows a schematic road map detail.

### DETAILED DESCRIPTION

Although the methods and systems described herein are applicable to any information systems having an information supply delivered from an external site or a control center to a plurality of information addressees, the exemplary embodiments and exemplary methods of the present invention (and the problem on which they are based) are explained with respect to an on-board navigation system in an automobile and its connection to a central traffic control system.

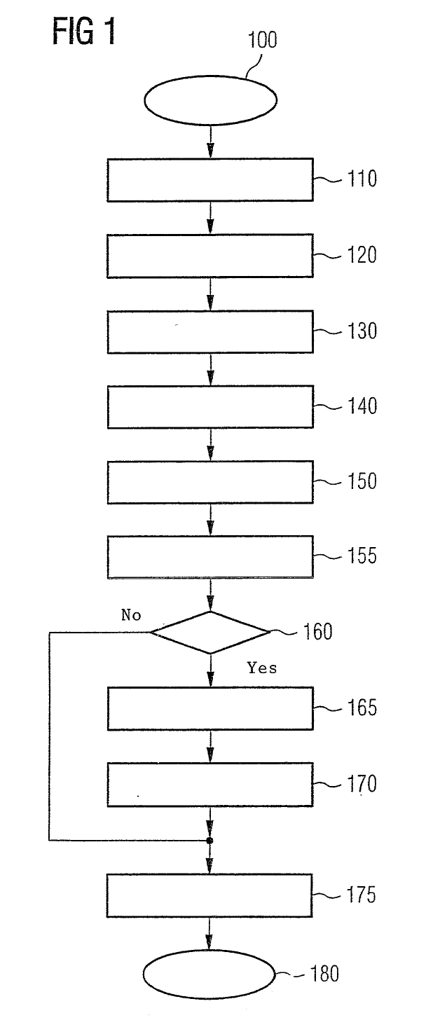

FIG. 1 shows a schematic block diagram of the steps of an exemplary embodiment during the trip.

In a step 100, the user starts the navigation system at the beginning of his/her trip.

In a step 110, he/she enters the trip destination. Then the vehicle navigation system determines the current location of the vehicle in step 120. In a step 130, the user's preference parameters are input by the system, i.e., whether the user would like to be guided along the fastest route or the shortest route, for example. In this case, the user selects the fastest route.

In a step 140, the on-board navigation system autonomously calculates the route desired by the user with the resources available in the vehicle such as traffic network stored data, e.g., from a database stored on a CD and from a computer.

Then in a step 150, the position of the vehicle, its destination, the preference parameters and a version ID number, characterizing the current version of the database stored in the vehicle navigation system are transmitted to the nearest traffic control center.

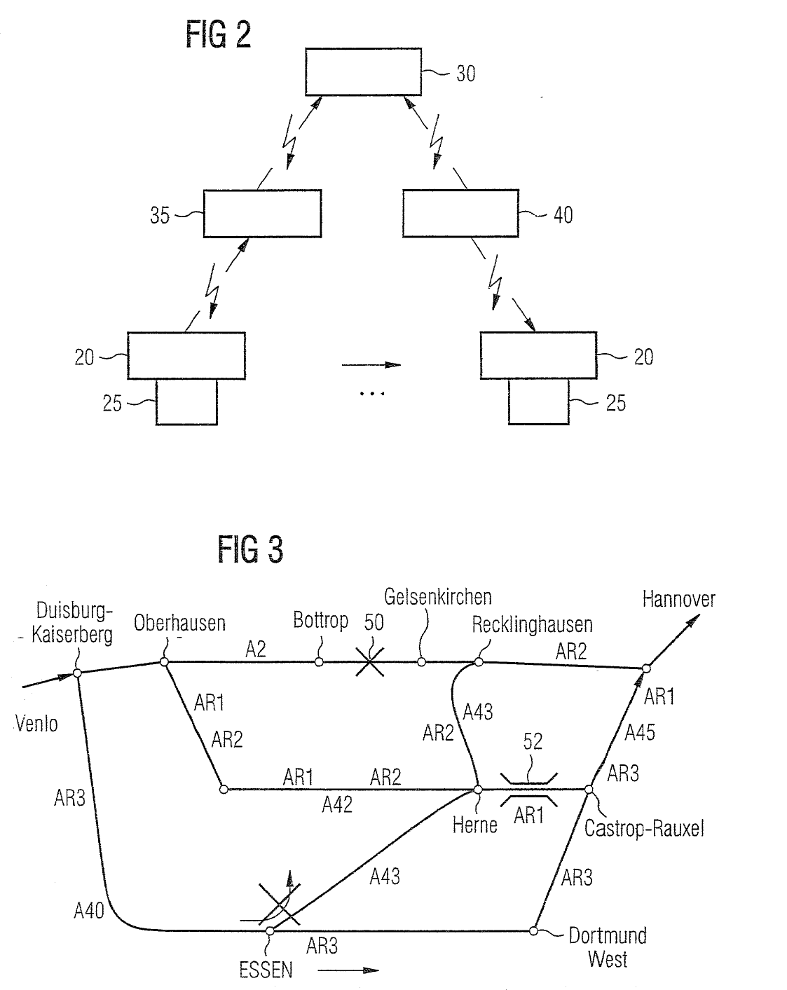

At this point, reference is also made to FIG. 2 at the same time. FIG. 2 shows a schematic diagram of the functional elements of the exemplary method. The left portion of FIG. 2 shows the motor vehicle with reference number 20. It has a navigation system 25. The control center referred to above is labeled as 30.

Data transmitted in step 150 by way of mobile wireless communication, including the position, destination, preference parameters and software version number, is indicated as minimum information in FIG. 2 and is shown with reference number 35.

With reference back to FIG. 1, the route for motor vehicle 20 is calculated in a step 155 in the control center, taking into account any possible traffic problems.

If there is no traffic problem which could be relevant for vehicle 20 at the moment or in the near future (see NO branch in decision tree 160), then there is a branch to step 175 where driving instructions from on-board data calculated by navigation device 25 are output to the driver until the destination is reached. Then the method is concluded in a step 180.

However, if a traffic problem which could be relevant for the planned trip of vehicle 20 in the corresponding time window is recorded in control center 30 (see YES branch of decision tree 160), then a detour route for bypassing the problem area is calculated in control center 30, and certain data defining the detour route around the disturbance is compiled for transmission to the vehicle. This delta data or delta information, as it is called, characterizes the detour route so completely that on-board navigation system 25 in vehicle 20 is able to synthesize trip instructions for the driver from this information so that the driver is able to navigate the detour route.

Then in a step 170, the delta data is transmitted to vehicle 20. The delta data is shown with reference number 40 in FIG. 2. The vehicle shown represents the same vehicle in each case. However, two vehicles 20 are shown, because it is moving between steps 150 and 170 (see back to FIG. 1).

In a step 175, the driving instructions obtained by vehicle navigation system 25 from delta data 40 are output to the driver until reaching the original route or the original destination of the trip. It should be pointed out here that after returning to the original route, i.e., after driving the entire detour route, the vehicle navigation system again directs the driver further autonomously and independently of the control center. Then in the remaining course of the route, the same or a different traffic control center may again be consulted for possible updates of the trip route according to the same principle as that illustrated in FIGS. 1 and 2.

With a supplementary reference to FIG. 3, which illustrates a schematic detail of a road map, the exemplary method of the present invention is described below on the basis of a specific traffic situation.

A vehicle is coming from the direction of Venlo and traveling in the direction of Hannover, but the actual starting and destination points are not relevant in this example.

The optimal route when selecting the “fastest” route here would lead over A2 after the Duisburg-Kaiserberg highway intersection. In the case of a complete blockage 50 on A2 between Bottrop and Gelsenkirchen, one possible alternative route AR1 for an autonomous navigation device would go over A42, starting at the highway intersection at Oberhausen to the highway intersection at Castrop-Rauxel and then over A45 back to A2.

However, the traffic control center is aware that a construction site 52 exists on A42 before Castrop-Rauxel, and although it has not yet created any obstacles, that might be the case under some circumstances due to an increased traffic flow. Therefore, certain delta information for an alternative route AR2 is transmitted to the vehicle navigation system, and then by reading and optionally further processing this information, the vehicle navigation system is able to suggest driving along an alternative route AR2 from the Oberhausen highway intersection over A42 to the Herne highway intersection and then over A43 to Recklinghausen and back to A2.

If there is already too much traffic on this road section, a portion of it could be directed as described and another portion could be directed along an alternative route AR3 starting at the Duisburg-Kaiserberg highway intersection, then over A40 to the Dortmund-West highway intersection and then over A45 back to A2, i.e., not over A43 from the Essen highway intersection to Recklinghausen because there would be too much traffic at construction site 52 and on A43 between Herne and Recklinghausen.

As more vehicles are equipped with such systems, it will then be more feasible to influence traffic in the sense of managing it through a control center in a better and more comprehensive manner.

Although the exemplary embodiment and/or exemplary method of the present invention have been described herein, they are not intended to be limiting and may be modified in a variety of ways. For example, data transmitted from the vehicle to the control center or from the control center to the vehicle may also be compressed by a suitably appropriate or available method to further reduce the volume of data to be transmitted.

The methods described herein are also nestable in many stages in the sense that in the case of two-stage nesting, for example, the delta data for a tertiary detour route leading away from the primary main route for which a secondary detour route has been already proposed may be put through and processed.

What is claimed is:

1. A navigation method for use in vehicle navigation systems (25) in which a route is calculated in an on-board vehicle navigation system (25) in a vehicle (20), and information from a control center (30) is transmitted to the vehicle information system (25) for the purpose of optimized route planning, characterized by the step in which only the delta information (40) representing the required necessary deviations from the previously calculated route for driving an alternative section of the route is transmitted from the control center to the vehicle navigation system (25).

2. The method according to claim 1, including the step of transmitting the current vehicle position, the destination of the route and the database version information to the control center (30) to initiate an optimized route planning.

3. A method for controlled management of motor vehicle traffic flow, in which information is transmitted from a control center (30) to on-board vehicle navigation systems (25) in the vehicles (20) for the purpose of preventing traffic problems, including the step of distributing the traffic flow among a plurality of detour segments (AR1, AR2, AR3) in a controlled manner when there is a traffic problem and a plurality of feasible detour routes are available.

4. A vehicle navigation system set up for carrying out the method according to one of the preceding claims 1 and 2.

5. A program for use in a traffic control center (30) containing program code suitable for executing the method according to claim 3.
